(19) United States
(12) Patent Application Publication
(10) Pub. No.: US 2009/0234039 A1
(43) Pub. Date: Sep. 17, 2009

(54) SHOE SOLES DISPLAYING WATER ABSORBING PROPERTIES

(75) Inventors: Markus Schütte, Osnabrück (DE); Andre Kamm, Lemförde (DE); Raffaela Villa, Comun Nuovo (IT); Davide Fusetti, Turate (IT)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/300,338

(22) PCT Filed: May 16, 2007
(86) PCT No.: PCT/EP07/54782

§ 371 Date: Nov. 11, 2008

(30) Foreign Application Priority Data
May 22, 2006 (EP) 06114342.6

(51) Int. Cl. C08L 75/04

(52) U.S. Cl. 521/137

(57) ABSTRACT

The present invention relates to a batch process for producing a polyurethane foam that comprises mixing (a) polyisocyanates with (b) at least one higher molecular weight compound having at least two reactive hydrogen atoms and (c) if appropriate low molecular weight chain-extending and/or crosslinking agents, (d) blowing agents comprising if appropriate water, (e) catalysts, (f) water-absorbing polymers, (g) if appropriate capsules containing latent heat storage media and (h) if appropriate miscellaneous additive materials, and reacting the resulting reaction mixture to form the polyurethane foam, wherein either the blowing agent d) comprises no water or if the blowing agent d) comprises water, blowing agent d) and water-absorbing polymer f) are only brought into contact in the course of the reaction mixture being formed. The invention further relates to polyurethane foams obtainable by such a process and to shoe soles comprising such a polyurethane foam.

The present invention relates to a batch process for producing a polyurethane foam that comprises mixing (a) polyisocyanates with (b) at least one higher molecular weight compound having at least two reactive hydrogen atoms and (c) if appropriate low molecular weight chain-extending and/or crosslinking agents, (d) blowing agents comprising if appropriate water, (e) catalysts, (f) water-absorbing polymers, (g) if appropriate capsules containing latent heat storage media and (h) if appropriate miscellaneous additive materials, and reacting the resulting reaction mixture to form the polyurethane foam, wherein either the blowing agent d) comprises no water or if the blowing agent d) comprises water, blowing agent d) and water-absorbing polymer f) are only brought into contact in the course of the reaction mixture being formed. The invention further relates to polyurethane foams obtainable by such a process and to shoe soles comprising such a polyurethane foam.

Further embodiments of the present invention are discernible from the claims, the description and the examples. It will be appreciated that the hereinbefore specified and the hereinbelow to be elucidated features of the subject matter of the present invention are utilizable not only in the particular combination indicated but also in other combinations without leaving the realm of the invention.

A pleasant climate is important for human well-being. More particularly, the temperature and humidity of the microclimate in the immediate vicinity of the body or skin play an important part. This microclimate is generally influenced by clothing.

Clothing should ideally augment the body's own thermoregulating mechanisms. Sweating is one such mechanism. To remove excess heat, for example, the body gives off moisture which evaporates on the surface of the skin. In the process, the body loses heat in the form of heat of evaporation.

If this moisture cannot be removed from the skin surface, for example since the clothing does not support the transfer of moisture to the outside, the air close to the skin quickly becomes saturated with moisture and additional moisture is not able to evaporate. This eliminates the cooling effect, leading to increased sweating. This excessive sweating severely impairs the sense of well being.

The removal of moisture is particularly problematical in the region of shoes, helmets or carrying straps, as of backpacks or rucksacks for example. Polyurethane foams are particularly suitable for such applications because of their low weight and excellent cushioning properties, but they frequently only have insufficient absorptive capacity for water. The absorptive capacity of the materials for water can be increased, for example, through hydrophilic polyurethane foams, in which case the hydrophilicity of the foams can be achieved by using polar polyols such as for example polyesterols or specific polyetherols having high levels of ethylene oxide (EO). Examples relating thereto are to be found in the references U.S. Pat. No. 3,861,993, U.S. Pat. No. 3,889,417 and WO 2004074343. One disadvantage of such materials is that their volume swells up when they absorb large amounts of moisture. Furthermore, foams having comparatively low elasticities and comparatively high compression sets are obtained. This is a particular disadvantage when such materials are used as insoles.

A further approach to increasing the water-absorbing capacity is to use water-absorbing particles. WO 03097345 discloses a hydrophilic polyurethane foam having a water-absorbing polymer content of not more then 0.1% by weight, which is said to enable moisture transportation in the polyurethane foam material. According to WO 03097345, a higher level of water-absorbing polymer causes it to gel in regions having a high moisture content and thereby block the transportation of moisture. WO 03097345 further discloses that the polyurethane foam is produced using an aqueous phase comprising the water-absorbing polymer.

WO 9744183 likewise discloses the use of water-absorbing particles in a polyurethane foam. The foams disclosed in WO 9744183 are produced in the form of blocks. These blocks are obtained in a continuous manner by conversion of a hydrophilic isocyanate prepolymer combined with acrylic latex and water and are subsequently thermoformed in a further operation into soles. In this process, the isocyanate is reacted with a high stoichiometric excess of water. The prepolymers used are obtained by reaction of TDI or MDI with hydrophilic polyetherols and generally have NCO contents between 5 and 8%. The water-absorbing polymer is used together with the isocyanate-reactive component.

The systems disclosed in WO 03097345 and WO 9744183 have to undergo subsequent, additional steps to rid them of excess water by storage in an oven, and to confer their final shape on them.

A large proportion of polyurethane foam manufactured these days is produced in a batch operation in which an accurately dimensioned amount of reaction mixture is introduced into a mold and cured therein to form a molded article. In the process, an isocyanate component reacts with an isocyanate-reactive component comprising a comparatively highly molecular weight compound having at least two reactive hydrogen atoms, blowing agents, catalysts and if appropriate low molecular weight chain-extending and/or crosslinking agents and other additive materials. As part of the move away from the use of physical blowing agents, for example hydrofluorochlorocarbons, there is a switch toward systems comprising water as a blowing agent, if appropriate as sole blowing agent. These systems typically comprise between 0.1% and 10% by weight of water, based on the total weight of the components used other than the isocyanate component.

It has emerged to be advantageous in relation to the batch production of foams for the mixtures to be introduced directly into a mold and for the production of the foam and also its shaping to take place in one step. This eliminates the need for later additional forming, molding or shaping operations and the associated extra expense or inconvenience due to, for example, secondary finishing of the formed, molded or shaped articles and also trimming waste.

Owing to their properties, water-absorbing polymers can only be used, if at all, in the isocyanate component or in the water-containing isocyanate-reactive component in very low proportions, as the swell on contact with water can thereby substantially raise the viscosity of the polyol component. This leads to limited miscibility for the isocyanate component with isocyanate-reactive component and hence to inhomogeneous products.

The present invention has for its object to provide a simple process for producing polyurethane foams comprising up to 20% by weight of water-absorbing polymer, based on the total weight of the polyurethane foam.

The present invention further has for its object to provide a polyurethane foam comprising 1% to 20% by weight of water-absorbing polymer, based on the total weight of the polyurethane.

We have found that this object is achieved in the present invention by a batch process for producing a polyurethane foam that comprises mixing (a) polyisocyanates with (b) at least one higher molecular weight compound having at least two reactive hydrogen atoms and (c) if appropriate low molecular weight chain-extending and/or crosslinking agents, (d) blowing agents comprising if appropriate water, (e) catalysts, (f) water-absorbing polymers, (g) if appropriate capsules containing latent heat storage media and (h) if appropriate miscellaneous additive materials, and reacting the resulting reaction mixture to form the polyurethane foam, wherein either the blowing agent d) comprises no water or if the blowing agent d) comprises water, blowing agent d) and water-absorbing polymer f) are only brought into contact in the course of the reaction mixture being formed. This invention is further achieved by polyurethane foams obtainable by a process of the present invention and also by shoe soles comprising such a polymer.

Polyurethane foams for the purposes of the present invention comprise any kind of polyurethane foam. Particular preference is given to flexible foams and also to microcellular elastomers, for example foams as typically used in shoe applications, for example as an insole, as a midsole or as a molded sole, or else foams as used in cushioning materials, for example in arm protectors.

The polyisocyanates (a) used for producing the polyurethane foams of the present invention comprise the prior art aliphatic, cycloaliphatic and aromatic di- or more highly functional isocyanates (constituent a-1) and also any desired mixtures thereof. Examples are 4,4′-diphenylmethane diisocyanate, 2,4-diphenylmethane diisocyanate, the mixtures of monomeric diphenylmethane diisocyanates and more highly nuclear homologs of diphenylmethane diisocyanate (polymer MDI), tetramethylene diisocyanate, hexamethylene diisocyanate (HDI), tolylene diisocyanate (TDI) or mixtures thereof.

Preference is given to using 4,4′-MDI and/or HDI. The particularly preferred 4,4′-MDI may comprise small amounts, up to about 10% by weight, of allophanate- or uretoneimine-modified polyisocyanates. Small amounts of polyphenylene polymethylene polyisocyanate (polymer MDI) can also be used. The total amount of these highly functional polyisocyanates should not exceed 5% by weight of the isocyanate used.

The polyisocyanate component (a) is preferably used in the form of polyisocyanate prepolymers. These polyisocyanate prepolymers are obtainable by reacting above-described polyisocyanates (a-1), for example at temperatures of 30 to 100° C. and preferably at about 80° C., with polyols (a-2) to give the prepolymer. The prepolymers of the present invention are preferably prepared using 4,4′-MDI together with uretoneimine-modified MDI and commercially available polyols based on polyesters, for example proceeding from adipic acid, or polyethers, for example proceeding from ethylene oxide or propylene oxide.

Polyols (a-2) are known to one skilled in the art and are described for example in “Kunststoffhandbuch, 7, Polyurethane”, Carl Hanser Verlag, 3rd edition 1993, chapter 3.1.

Ether-based prepolymers are preferably obtained by reaction of polyisocyanates (a-1), more preferably 4,4′-MDI, with 2- to 3-functional polyoxypropylene polyols and/or polyoxypropylene-polyoxyethylene polyols. They are most commonly prepared by the commonly known base-catalyzed addition of propylene oxide alone or mixed with ethylene oxide onto H-functional and in particular OH-functional starting substances. Useful starting substances include for example water, ethylene glycol or propylene glycol and glycerol or trimethylolpropane. For example, polyethers as described hereinbelow under (b) can be used as component (a-2).

When ethylene oxide-propylene oxide mixtures are used, the ethylene oxide is preferably used in an amount of 10-50% by weight, based on the total amount of alkylene oxide. The alkylene oxides may be incorporated blockwise or as a random mixture. It is particularly preferable to incorporate an ethylene oxide cap in order that the level of more reactive primary OH end groups may be increased.

Preference is given to using diols based on polyoxypropylene having 10% to 30% and preferably 12.5% to 20% by weight of polyoxyethylene units at the chain end, so that more than 80% of the OH groups are primary OH groups. A particularly preferred embodiment utilizes mixtures of diols based on polyoxypropylene and polyoxypropylene-polyoxyethylene. The hydroxyl number (OH number) of these diols is preferably between 20 and 100 mg of KOH/g.

The comparatively high molecular weight compounds (b) having at least two reactive hydrogen atoms are advantageously those having a functionality of 2 to 8 and an OH number of 9 to 1150 mg of KOH/g. Examples which will prove advantageous are polyetherpolyamines and/or preferably polyols selected from the group of the polyether polyols, polyester polyols, prepared from alkanedicarboxylic acids and polyhydric alcohols, polythioether polyols, polyesteramides, hydroxyl-containing polyacetals and hydroxyl-containing aliphatic polycarbonates or mixtures of two or more of the polyols mentioned. Preference is given to using polyester polyols and/or polyether polyols. By contrast, alkyd resins or polyester molding compounds having reactive, olefinically unsaturated double bonds are unsuitable for use as comparatively high molecular weight compounds (b) having at least two reactive hydrogen atoms.

Preference is given to using polyetherols. Suitable polyether polyols are obtainable in a known manner, for example by anionic polymerization with alkali metal hydroxides, such as sodium hydroxide or potassium hydroxide, or alkali metal alkoxides, such as sodium methoxide, sodium ethoxide, potassium ethoxide or potassium isopropoxide as catalysts and in the presence of at least one starter molecule comprising 2 to 8 reactive hydrogen atoms in bonded attachment, or by means of double metal cyanide catalysts as described for example in EP 90444 or WO 05/090440.

Useful alkylene oxides include for example tetrahydrofuran, 1,3-propylene oxide, 1,2-butylene oxide, 2,3-butylene oxide, styrene oxide, and preferably ethylene oxide and 1,2-propylene oxide. Alkylene oxides can be used individually, alternatingly in succession or as mixtures. Useful starter molecules include for example water, polyhydric, in particular di- to octahydric alcohols, such as ethanediol, 1,2-propanediol, 1,3-propanediol, diethylene glycol, dipropylene glycol, 1,4-butanediol, 1,6-hexanediol, glycerol, trimethylolpropane, pentaerythritol, sorbitol and sucrose, organic dicarboxylic acids, such as succinic acid, adipic acid, phthalic acid and terephthalic acid, aliphatic and aromatic unsubstituted or N-monoalkyl-, N,N-dialkyl- and N,N′-dialkyl-substituted diamines having 1 to 4 carbon atoms in the alkyl radical, such as unsubstituted or mono- and dialkyl-substituted ethylenediamine, diethylenetriamine, triethylenetetramine, 1,3-propylenediamine, 1,3-butylenediamine, 1,4-butylenediamine, 1,2-hexamethylenediamine, 1,3-hexamethylenediamine, 1,4-hexamethylenediamine, 1,5-hexamethylenediamine, 1,6-hexamethylenediamine, phenylenediamines, 2,3-tolylenediamine, 2,4-tolylenediamine, 2,6-tolylenediamine, 4,4′-diaminodiphenylmethane, 2,4′-diaminodiphenylmethane and 2,2′-diaminodiphenylmethane.

Useful starter molecules further include alkanolamines, such as ethanolamine, diethanolamine, N-methylethanolamine, N-ethylethanolamine, N-methyldiethanolamine, N-ethyldiethanolamine, triethanolamine and ammonia.

Preference is given to using polyhydric, in particular di- to octahydric, alcohols, such as ethanediol, 1,2-propanediol, 1,3-propanediol, diethylene glycol, dipropylene glycol, 1,4-butanediol, 1,6-hexanediol, glycerol, trimethylolpropane, pentaerythritol, sorbitol and sucrose.

The polyether polyols, preferably polyoxypropylene polyols and polyoxypropylene-polyoxyethylene polyols having ethylene oxide end blocks, have a functionality of preferably 2 to 4 and in particular 2 and/or 3 and preferably an OH number between 12 and 155 mg of KOH/g and in particular between 20 and 75 mg of KOH/g. Useful polyols further include polymer-modified polyols, preferably polymer-modified polyesterols or polyetherols, more preferably graft polyetherols or graft polyesterols, in particular draft polyetherols. These are what is known as a polymer polyol, which usually comprises 5% to 60% by weight, preferably 10% to 55% by weight, more preferably 30% to 55% by weight and especially 40% to 50% by weight of a polymer, preferably of a thermoplastic polymer. These polymer polyols are described for example in U.S. Pat. No. 4,342,840 and EP-A-250 351 and are typically prepared by free radical polymerization of suitable olefinic monomers, for example styrene, acrylonitrile, (meth)acrylates, methacrylic acid and/or acrylamide, in a polyesterol or polyetherol serving as a grafting base. The side chains are generally produced by transfer of the free radicals from growing polymer chains to polyesterols or polyetherols. The polymer polyol, as well as the graft copolymer, predominantly comprises the homopolymers of the olefins, dispersed in unaltered polyesterol or polyetherol.

One preferred embodiment utilizes acrylonitrile, styrene, in particular exclusively styrene, as monomers. The monomers are polymerized in the presence or absence of further monomers, of a macromer, of a moderator and using a free radical initiator, mostly azo compounds or peroxide compounds, in a polyesterol or polyetherol as a continuous phase.

The macromers become co-incorporated in the copolymer chain during the free radical polymerization. The products are block copolymers having a polyester or polyether block and a poly-acrylonitrile-styrene block, which act as compatibilizers at the interface of continuous phase and disperse phase and suppress agglomeration of the polymer polyesterol particles. The fraction of macromers is typically in the range from 1% to 20% by weight, based on the total weight of the monomers used for preparing the polymer polyol.

Preferably, the fraction of polymer polyol is greater than 5% by weight, based on the total weight of component (b). Polymer polyols may be included for example in an amount of 7% to 90% by weight or of 11% to 80% by weight, based on the total weight of component (b). It is particularly preferable for the polymer polyol to be polymer polyesterol or polymer polyetherol.

The polyurethane foams of the present invention can be produced with or without the use of (c) chain-extending and/or crosslinking agents. However, to modify mechanical properties, for example hardness, the addition of chain-extending agents, crosslinking agents or else, if appropriate, mixtures thereof can prove to be advantageous. Useful chain-extending and/or crosslinking agents include substances having at least two isocyanate-reactive groups, such as OH or amine groups. Preference is given to using diols and/or triols having molecular weights of less than 400, preferably of 60 to 300 and in particular 60 to 150. Contemplated are for example aliphatic, cycloaliphatic and/or araliphatic diols having 2 to 14 and preferably 2 to 10 carbon atoms, such as ethylene glycol, 1,3-propanediol, 1,10-decanediol, o-dihydroxycyclohexane, m-dihydroxycyclohexane, p-dihydroxycyclohexane, diethylene glycol, dipropylene glycol and preferably 1,4-butanediol, 1,6-hexanediol and bis(2-hydroxyethyl)-hydroquinone, triols, such as 1,2,4-trihydroxycyclohexane, 1,3,5-trihydroxycyclohexane, glycerol and trimethylolpropane, and low molecular weight hydroxyl-containing polyalkylene oxides based on ethylene oxide and/or 1,2-propylene oxide and the aforementioned diols and/or triols as starter molecules. Particular preference is given to using monoethylene glycol, 1,4-butanediol and/or glycerol as chain extenders c).

If chain-extending agents, crosslinking agents or mixtures thereof are used, they are advantageously used in amounts of 1% to 60% by weight, preferably 1.5% to 50% by weight and in particular 2% to 40% by weight, based on the weight of components (b) and (c).

Polyurethane foams are additionally produced in the presence of blowing agents (d). These blowing agents comprise water (as constituent (d-1)) if appropriate. As well as water (d-1), well-known chemically and/or physically acting compounds can be used as blowing agents (d) in which case the further chemical blowing agents are termed constituent (d-2) and the physical blowing agents as constituent (d-3). Chemical blowing agents are compounds which react with isocyanate to form gaseous products, examples being water or formic acid. Physical blowing agents are compounds which are dissolved or emulsified in the materials used for polyurethane production, and vaporize under the conditions of polyurethane formation. They are for example hydrocarbons, halogenated hydrocarbons, and other compounds, examples being perfluorinated alkanes, such as perfluorohexane, (hydro)chlorofluorocarbons, and ethers, esters, ketones and/or acetals, examples being (cyclo)aliphatic hydrocarbons having 4 to 8 carbon atoms, or hydrofluorocarbons, such as Solkane® 365 mfc from Solvay. One preferred embodiment utilizes a blowing agent comprising a mixture of these blowing agents, comprising water, in particular water as sole blowing agent. When water is not used as a blowing agent, it is preferable to use physical blowing agents only.

The level of (d-1) water is in one preferred embodiment from 0.1% to 2% by weight, preferably 0.2% to 1.5% by weight, more preferably 0.3% to 1.2% by weight and especially 0.4% to 1% by weight, based on the total weight of components (a) to (h). Water (d-1) here comprises not just water added as a separate component, but also water present in one of the components (b) to (h) for example.

A further preferred embodiment comprises adding to the reaction of components (a), (b) and if appropriate (c), as an additional blowing agent, microbeads that contain physical blowing agent. The microbeads can also be used in admixture with the aforementioned additional chemical blowing agents (d-2) and/or physical blowing agents (d-3).

The microbeads typically consist of a shell of thermoplastic polymer and are filled on the inside with a liquid, low-boiling substance based on alkanes. The production of such microbeads is described for example in U.S. Pat. No. 3,615,972. The microbeads are generally from 5 to 50 μm in diameter. Examples of suitable microbeads are available under the trade name Expancell® of Akzo Nobel.

The microbeads are generally added in an amount of 0.5% to 5%, based on the total weight of components (b), (c) and (d).

Catalysts (e) for producing the polyurethane foams are preferably compounds which strongly speed the reaction of the hydroxyl-containing compounds of component (b) and if appropriate (c) with the polyisocyanates (a). Suitable examples are amidines, such as 2,3-dimethyl-3,4,5,6-tetrahydropyrimidine, tertiary amines, such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo(3,3,0)octane, preferably 1,4-diazabicyclo(2,2,2)-octane and alkanolamine compounds, such as triethanolamine, triisopropanolamine, N-methyldiethanolamine, N-ethyldiethanolamine and dimethylethanolamine. Also contemplated are organic metal compounds, preferably organotin compounds, such as tin(II) salts of organic carboxylic acids, for example tin(II) acetate, tin(II) octoate, tin(II) ethylhexanoate and tin(II) laurate and the dialkyltin(IV) salts of organic carboxylic acids, examples being dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate or mixtures thereof. The organometal compounds can be used alone or preferably in combination with strong basic amines. When component (b) is an ester, it is preferable to employ amine catalysts only.

Water-absorbing polymers (f) are in particular polymers of (co)polymerized hydrophilic monomers such as for example partially neutralized acrylic acid, 2-hydroxyethyl methacrylate and 2-hydroxyethyl acrylate, graft (co)polymers of one or more hydrophilic monomers on a suitable grafting base, crosslinked ethers of cellulose or of starch, crosslinked carboxymethylcellulose, partially crosslinked polyalkylene oxide, partially crosslinked polyvinylpyrrolidone or polyvinylpyrrolidone copolymers, or natural products swellable in aqueous fluids, examples being guar derivatives or bentonites, of which water-absorbing polymers (f) based on partially neutralized acrylic acid are preferred. Such polymers are used as absorbent products for producing diapers, tampons, sanitary napkins and other hygiene articles, but also as water-retaining agents in market gardening.

The production of water-absorbing polymers (f) is described for example in the monograph “Modern Superabsorbent Polymer Technology”, F. L. Buchholz and A. T. Graham, Wiley-VCH, 1998, or in Ullmann's Encyclopedia of Industrial Chemistry, 6th edition volume 35 pages 73 to 103. The preferred method of making is the solution or gel polymerization process. In this process, the first step is to prepare a monomer mixture which is batch neutralized and then transferred into a polymerization reactor, or is already present in the polymerization reactor as an initial charge. The subsequent batch or continuous operation includes the reaction to form the polymer gel, which in the case of a stirred polymerization is already comminuted. The polymer gel is subsequently dried, ground and sieved and then transferred for further surficial treatment.

The water-absorbing polymers are obtained for example by polymerization of a monomer solution comprising
aa) at least one ethylenically unsaturated carboxylic acid and/or sulfonic acid,
bb) at least one crosslinker,
cc) selectively one or more ethylenically and/or allylically unsaturated monomers copolymerizable with the monomer aa) and
dd) selectively one or more water soluble polymers onto which the monomers aa), bb) and if appropriate cc) can be at least partly grafted.

Useful ethylenically unsaturated carboxylic acids and sulfonic acids aa) include for example acrylic acid, methacrylic acid, maleic acid, fumaric acid, crotonic acid, 4-pentenoic acid, 2-acrylamide-2-methylpropanesulfonic acid, vinylsulfonic acid, 3-allyoxy-2-hydroxypropane-1-sulfonate and itaconic acid. Acrylic acid and methacrylic acid are particularly preferred monomers. Acrylic acid is very particularly preferred.

The monomers aa) and especially acrylic acid comprise preferably up to 0.025% by weight of a hydroquinone half ether. Preferred hydroquinone half ethers are hydroquinone monomethyl ether (MEHQ) and/or tocopherols.

Tocopherol refers to compounds of the following formula:

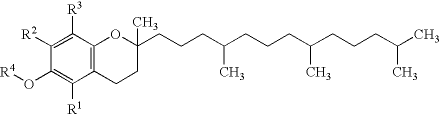

where R¹ is hydrogen or methyl, R² is hydrogen or methyl, R³ is hydrogen or methyl and R⁴ is hydrogen or an acyl radical of 1 to 20 carbon atoms.

Preferred R⁴ radicals are acetyl, ascorbyl, succinyl, nicotinyl and other physiologically tolerable carboxylic acids. The carboxylic acids can be mono-, di- or tricarboxylic acids.

Preference is given to alpha-tocopherol where R¹=R²=R³=methyl, especially racemic alpha-tocopherol. R¹ is more preferably hydrogen or acetyl. RRR-alpha-tocopherol is preferred in particular.

The monomer solution comprises preferably not more than 130 weight ppm, more preferably not more than 70 weight ppm, preferably not less than 10 weight ppm, more preferably not less than 30 weight ppm and especially about 50 weight ppm of hydroquinone half ether, all based on acrylic acid, with acrylic acid salts being counted as acrylic acid. For example, the monomer solution can be produced using an acrylic acid having an appropriate hydroquinone half ether content.

The crosslinkers bb) are compounds having at least two polymerizable groups which can be free-radically interpolymerized into the polymer network. Suitable crosslinkers bb) are for example ethylene glycol dimethacrylate, diethylene glycol diacrylate, allyl methacrylate, trimethylolpropane triacrylate, triallylamine, tetraallyloxyethane, as described in EP-A-0 530 438, di- and triacrylates, as described in EP-A-0 547 847, EP-A-0 559 476, EP-A-0 632 068, WO-A-93/21237, WO-A-03/104299, WO-A-03/104300, WO-A-03/104301 and DE-A-103 31 450, mixed acrylates which, as well as acrylate groups, comprise further ethylenically unsaturated groups, as described in DE-A-103 31 456 and WO-A-04/013064, or crosslinker mixtures as described for example in DE-A-195 43 368, DE-A-196 46 484, WO-A-90/15830 and WO-A-02/32962.

Useful crosslinkers bb) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A-0 343 427. Useful crosslinkers bb) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. The process of the invention utilizes di(meth)-acrylates of polyethylene glycols, the polyethylene glycol used having a molecular weight between 300 and 1000.

However, particularly advantageous crosslinkers bb) are di- and triacrylates of 3- to 15-tuply ethoxylated glycerol, of 3- to 15-tuply ethoxylated trimethylolpropane, of 3- to 15-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol, of 3-tuply propoxylated trimethylolpropane, and also of 3-tuply mixedly ethoxylated or propoxylated glycerol, of 3-tuply mixedly ethoxylated or propoxylated trimethylolpropane, of 15-tuply ethoxylated glycerol, of 15-tuply ethoxylated trimethylolpropane, of 40-tuply ethoxylated glycerol, of 40-tuply ethoxylated trimethylolethane and also of 40-tuply ethoxylated trimethylolpropane.

Very particularly preferred for use as crosslinkers bb) are diacrylated, dimethacrylated, triacrylated or trimethacrylated multiply ethoxylated and/or propoxylated glycerols as described for example in WO-A-03/104301. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 weight ppm) in the water-absorbing polymer and the aqueous extracts of water-absorbing polymers produced therewith have an almost unchanged surface tension (typically not less than 0.068 N/m) compared with water at the same temperature.

Examples of ethylenically unsaturated monomers cc) which are copolymerizable with the monomers aa) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers dd) include polyvinyl alcohol, polyvinylpyrrolidone, starch, starch derivatives, polyglycols, in particular dihydric and trihydric polyols based on ethylene oxide and/or propylene oxide, or polyacrylic acids, preferably polyvinyl alcohol, polyglycols and starch.

The preferred polymerization inhibitors require dissolved oxygen for optimum performance. Typically, polymerization solutions are freed of dissolved oxygen prior to polymerization by inertization, i.e., by flowing an inert gas, preferably nitrogen, through them. This distinctly weakens the effect of the polymerization inhibitors. The oxygen content of the monomer solution is preferably lowered to less than 1 weight ppm and more preferably to less than 0.5 weight ppm prior to polymerization.

The preparation of a suitable base polymer and also further useful hydrophilic ethylenically unsaturated monomers dd) are described in DE-A-199 41 423, EP-A-0 686 650, WO-A-01/45758 and WO-A-03/104300.

Water-absorbing polymers are typically obtained by addition polymerization of an aqueous monomer solution with or without subsequent comminution of the hydrogel. Suitable methods of making are described in the literature. Water-absorbing polymers are obtainable for example by
gel polymerization in the batch process or tubular reactor and subsequent comminution in meat grinder, extruder or kneader (EP-A-0 445 619, DE-A-198 46 413)
addition polymerization in kneader with continuous comminution by contrarotatory stirring shafts for example (WO-A-01/38402)
addition polymerization on belt and subsequent comminution in meat grinder, extruder or kneader (DE-A-38 25 366, U.S. Pat. No. 6,241,928)
emulsion polymerization, which produces bead polymers having a relatively narrow gel size distribution (EP-A-0 457 660)
in situ addition polymerization of a woven fabric layer which, usually in a continuous operation, has previously been sprayed with aqueous monomer solution and subsequently been subjected to a photopolymerization (WO-A-02/94328, WO-A-02/94329)

The reaction is preferably carried out in a kneader as described for example in WO-A-01/38402, or on a belt reactor as described for example in EP-A-0 955 086. Neutralization can be carried out to some extent after polymerization, at the hydrogel stage. It is therefore possible to neutralize up to 40 mol %, preferably from 10 to 30 mol % and more preferably from 15 to 25 mol % of the acid groups before polymerization by adding a portion of the neutralizing agent to the monomer solution and setting the desired final degree of neutralization only after polymerization, at the hydrogel stage. The monomer solution can be neutralized by admixing the neutralizing agent. The hydrogel may be mechanically comminuted, for example by means of a meat grinder, in which case the neutralizing agent can be sprayed, sprinkled or poured on and then carefully mixed in. To this end, the gel mass obtained can be repeatedly meat-grindered for homogenization. Neutralization of the monomer solution to the final degree of neutralization is preferred.

The neutralized hydrogel is then dried with a belt or drum dryer until the residual moisture content is preferably below 15% by weight and especially below 10% by weight, the water content being determined by EDANA (European Disposables and Nonwovens Association) recommended test method No. 430.2-02 “Moisture content”. Selectively, drying can also be carried out using a fluidized bed dryer or a heated plowshare mixer. To obtain particularly white products, it is advantageous to dry this gel by ensuring rapid removal of the evaporating water. To this end, the dryer temperature must be optimized, the air feed and removal has to be policed, and at all times sufficient venting must be ensured. Drying is naturally all the more simple—and the product all the more white—when the solids content of the gel is as high as possible. The solids content of the gel prior to drying is therefore preferably between 30% and 80% by weight. It is particularly advantageous to vent the dryer with nitrogen or some other nonoxidizing inert gas. Selectively, however, simply just the partial pressure of the oxygen can be lowered during drying to prevent oxidative yellowing processes. But in general adequate venting and removal of the water vapor will likewise still lead to an acceptable product. A very short drying time is generally advantageous with regard to color and product quality.

The dried hydrogel is preferably ground and sieved, useful grinding apparatus typically including roll mills, pin mills or swing mills. The particle size of the sieved, dry hydrogel is preferably below 1000 μm, more preferably below 800 μm and most preferably below 600 μm and preferably above 10 μm, more preferably above 50 μm and most preferably above 100 μm.

Very particular preference is given to a particle size (sieve cut) in the range from 106 to 850 μm. The particle size is determined according to EDANA (European Disposables and Nonwovens Association) recommended test method No. 420.2-02 “Particle size distribution”.

The base polymers are then preferably surface postcrosslinked. Useful postcrosslinkers are compounds comprising two or more groups capable of forming covalent bonds with the carboxylate groups of the hydrogel. Suitable compounds are for example alkoxysilyl compounds, polyaziridines, polyamines, polyamidoamines, di- or polyglycidyl compounds, as described in EP-A-0 083 022, EP-A-0 543 303 and EP-A-0 937 736, di- or polyfunctional alcohols, as described in DE-C-33 14 019, DE-C-35 23 617 and EP-A-0 450 922, or β-hydroxyalkylamides, as described in DE-A-102 04 938 and U.S. Pat. No. 6,239,230.

Useful surface postcrosslinkers are further said to include by DE-A-40 20 780 cyclic carbonates, by DE-A-198 07 502 2-oxazolidone and its derivatives, such as 2-hydroxyethyl-2-oxazolidone, by DE-A-198 07 992 bis- and poly-2-oxazolidinones, by DE-A-198 54 573 2-oxotetrahydro-1,3-oxazine and its derivatives, by DE-A-198 54 574 N-acyl-2-oxazolidones, by DE-A-102 04 937 cyclic ureas, by DE-A-103 34 584 bicyclic amide acetals, by EP-A-1 199 327 oxetanes and cyclic ureas and by WO-A-03/031482 morpholine-2,3-dione and its derivatives.

Postcrosslinking is typically carried out by spraying a solution of the surface postcrosslinker onto the hydrogel or onto the dry base polymeric powder. After spraying, the polymeric powder is thermally dried, and the crosslinking reaction may take place not only before but also during drying.

The spraying with a solution of the crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers.

Contact dryers are preferable, shovel dryers more preferable and disk dryers most preferable as apparatus in which thermal drying is carried out. Fluidized bed dryers can be used as well.

Drying may take place in the mixer itself, by heating the jacket or introducing a stream of warm air. It is similarly possible to use a downstream dryer, for example a tray dryer, a rotary tube oven or a heatable screw. But it is also possible for example to utilize an azeotropic distillation as a drying process.

Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and more preferably below 10 minutes.

The capsules (g) containing latent heat storage media comprise particles having a capsule core and a capsule wall. These particles are hereinbelow referred to as microcapsules. Latent heat storage media useful in this invention are specified for example in DE 102004031529.

The capsule core comprises predominantly and preferably to an extent of more than 95% by weight of latent heat storage media materials. The capsule wall comprises generally polymeric materials. The capsule core is solid or liquid, depending on the temperature.

Latent heat storage media materials are generally lipophilic substances which have their solid-liquid phase transition in the temperature range from −20 to 120° C. However, this invention utilizes latent heat storage media materials which have their solid-liquid phase transition in the range just below the temperature of the human body. Preference is given to using latent heat storage media materials which have their solid-liquid phase transition in the temperature range from 15 to 45° C., preferably from 20 to 40° C. and especially from 24 to 35° C.

The fraction of microcapsules (g) containing latent heat storage media is generally in the range from 0% to 30% by weight, preferably in the range from 1% to 20% by weight, more preferably in the range from 2% to 12% and especially in the range from 3% to 8% by weight of microcapsules (c), based on the total weight of the polyurethane foam. It is particularly preferable to use a combination of latent heat storage medium and water-absorbing polymer. It is preferable to use 3% to 8% by weight of latent heat storage medium and 1% to 10% by weight of water-absorbing polymer in a combination. This combination has the advantage that latent heat storage medium and water-absorbing polymer complement each other in influencing the microclimate at the body or skin surface.

The reaction mixture for producing the polyurethane foams may if appropriate also include auxiliaries and/or additives (h). Specific results are surface-active substances, foam stabilizers, cell regulators, release agents, fillers, dyes, pigments, hydrolysis control agents, odor-binders, fungistatic and bacteriostatic substances.

Useful surface-active substances include for example compounds which serve to support the homogenization of the starting materials and if appropriate are also capable of regulating the cell structure. Examples are emulsifiers, such as the sodium salts of castor oil sulfates or of fatty acids, and also salts of fatty acids with amines, for example diethylamine oleate, diethanolamine stearate, diethanolamine ricinoleate, salts of sulfonic acids, for example alkali metal or ammonium salts of dodecylbenzenedisulfonic or dinaphthylmethanedisulfonic acid and ricinoleic acid; foam stabilizers, such as siloxane-oxalkylene interpolymers and other organopolysiloxanes, ethoxylated alkylphenols, ethoxylated fatty alcohols, paraffin oils, castor oil esters or ricinoleic esters, Turkey red oil and peanut oil, and cell regulators, such as paraffins, fatty alcohols and dimethylpolysiloxanes. Oligomeric acrylates having polyoxyalkylene and fluoroalkane radicals as side groups are further useful for improving the emulsifying effect, the cell structure and/or stabilizing the foam. The surface-active substances are typically used in amounts of 0.01 to 5 parts by weight, based on 100 parts by weight of component (b).

Examples of useful release agents are reaction products of fatty acid esters with polyisocyanates, salts of amino-containing polysiloxanes and fatty acids, salts of saturated or unsaturated cycloaliphatic carboxylic acids having at least 8 carbon atoms and tertiary amines and also, in particular, inner release agents, such as carboxylic esters and/or amides, prepared by esterification or amidation of a mixture of montan acid and at least one aliphatic carboxylic acid having at least 10 carbon atoms with at least difunctional alkanolamines, polyols and/or polyamines having molecular weights of 60 to 400 (EP-A-1 53 639), mixtures of organic amines, metal salts of stearic acid and organic mono- and/or dicarboxylic acids and their anhydrides (DE-A-3 607 447) or mixtures of an imino compound, the metal salt of a carboxylic acid and if appropriate a carboxylic acid (U.S. Pat. No. 4,764,537).

Useful fillers, in particular reinforcing fillers, include the known customary organic and inorganic fillers, reinforcing agents, weighting agents, agents to improve the abrasion behavior in paints, coatings, etc. Specific examples are inorganic fillers such as silicatic minerals, for example sheet-silicates such as antigorite, bentonite, serpentine, hornblendes, amphiboles, chrysotile, talc; metal oxides, such as kaolin, aluminas, titanias, zinc oxide and iron oxides, metal salts such as chalk, barite and inorganic pigments, such as cadmium sulfide, zinc sulfide and also glass among others. Preference is given to using kaolin (china clay), aluminum silicate and coprecipitates formed from barium sulfate and aluminum silicate, and also natural and synthetic fibrous minerals such as wollastonite, metal fibers and in particular glass fibers of various lengths, which may each be coated if appropriate. Examples of useful organic fillers include carbon black, melamine, rosin, cyclopentadienyl resins and graft polymers and also cellulose fibers, polyamide fibers, polyacrylonitrile fibers, polyurethane fibers, polyester fibers based on aromatic and/or aliphatic dicarboxylic esters and, in particular, carbon fibers.

The organic and inorganic fillers can be used singly or as mixtures and are preferably included in the reaction mixture in amounts of 0.5% to 50% by weight and preferably 1% to 40% by weight, based on the weight of components (a) to (c), except that the level of mats, wovens and nonwovens composed of natural and synthetic fibers can reach values up to 80% by weight.

Any known odor-binder can be used. Examples of useful odor-binders are cyclodextrins, cucurbituril, calixarenes, metal organic frameworks (MOFs), as described for example in J. Mater. Chem., 2006, 16, 626-636, activated carbon, zeolites, sheet-silicates, such as bentonites, and metal oxides, for example zinc oxide.

Any fungistatic and bacteriostatic substance suitable for these purposes can be used, examples being metals or metal powders, such as silver, titanium, copper or zinc, or materials capable of releasing ions of these metals, such as silver zeolite A, quaternary ammonium compounds, polymeric compounds, such as chitin and chitosan, partially crosslinked polyacrylic acid and salts thereof or polyhexamethylene biguanides and natural materials, for example tea tree oil.

The polyurethane foams are produced by reacting the polyisocyanates (a), higher molecular weight compounds having at least two reactive hydrogen atoms (b) and if appropriate chain-extending and/or crosslinking agents (c) in such amounts that the equivalence ratio of NCO groups of the polyisocyanates (a) to the sum total of the reactive hydrogen atoms of components (b), (c), (d) and (e) is in the range from 0.75 to 1.25:1 and preferably in the range from 0.85 to 1.15:1. When the polyurethane foams at least partly comprise attached isocyanurate groups, it is customary to employ a ratio for the NCO groups of polyisocyanates (a) to the sum total of the reactive hydrogen atoms of components (b), (c) and (d) in the range from 1.5 to 20:1 and preferably in the range from 1.5 to 8:1. A 1:1 ratio corresponds to an isocyanate index of 100.

The polyurethane foams are advantageously produced by the one shot process, for example with the aid of reaction injection molding, high pressure or low pressure technology in open or closed molds, for example metallic molds, for example of aluminum, cast iron or steel.

In accordance with an essential feature of the present invention, water-absorbing polymer (f) and significant amounts of water are only brought into contact in the course of the reaction mixture being formed. Here “essential amounts of water” does not comprise the moisture which is usually present in the higher molecular weight compound having at least two reactive hydrogens (b) or chain extenders (c), but only further additions of water. More precisely, “essential amounts of water” is to be understood as meaning a water content of 0.1% by weight or more, based on the total weight of components (b) to (h).

When water is used as a blowing agent, i.e., when components (b) to (h) comprise more than 0.1% by weight of water, the reaction mixture is preferably obtained by mixing a polyol component (A1) and a polyol component (A2) with an isocyanate component (B) comprising (a) polyisocyanates. The polyol components (A1) and (A2) preferably each comprise a portion of the at least one higher molecular weight compound having at least two reactive hydrogen atoms (b), the component (A1) comprising no water-absorbing polymer and the component (A2) comprising essentially no water, i.e., preferably less than 0.1% by weight and more preferably less than 0.01% by weight of water.

When low molecular weight chain-extending agents (c) are used, these may be present in the polyol component (A1) or (A2) or in both. More preferably, component (A2) comprises no catalyst, in particular no amine catalyst. Components (g) and (h), if present, can likewise be used not only in component (A1) but also in component (A2). Preferably, the mixing ratios of components (b) to (h) in components (A1) and (A2) are set such that the viscosities of both the components differ by less than 50%, more preferably by less than 20% and in particular by less than 10%, based on the viscosity of the more viscous component.

As an alternative to dividing the polyol component into a polyol component (A1) and a polyol component (A2), the water-absorbing polymer can also be added as a solid material in a mixing head. In this embodiment, isocyanate component, polyol component and water-absorbing polymer are introduced separately into a mixing head and mixed therein to form the reaction mixture.

The starting components are mixed at a temperature in the range from 15 to 90° C. and preferably in the range from 20 to 50° C. and are introduced into the open mold or if appropriate, under elevated pressure, into the closed mold. Mixing can be effected mechanically by means of a stirrer or a stirring screw or under high pressure in the so-called countercurrent injection process. Low pressure processing is preferred. Mold temperature is advantageously in the range from 20 to 90° C., preferably in the range from 30 to 60° C. and in particular in the range from 45 to 50° C.

The polyurethane foams of the present invention are preferably substantially open-cell. Components (a) to (h) are chosen so that the polyurethane foam of the present invention comprises an open-cell foam. The polyurethane foams of the present invention preferably have an open-cell content of more than 90%, preferably of more than 93%, more preferably of more than 95% and in particular of more than 97%.

The polyurethane foams produced by the process of the present invention can be used wherever the removal of moisture from the skin or body surface is problematical, as in shoes, for example as shoe sole or as insole/footbed, in helmets, in carrying straps, for example for backpacks/rucksacks, in elbow and knee protectors, in the case of insocks (shoe inserts, mostly of foam material, which enclose the foot and are capable of absorbing impacts), for skiboots and rollerblades, in seats, for example automotive seats, or in mattresses. The density of the polyurethane foams can be set according to the planned application. The densities of polyurethane foams according to the present invention are typically in the range from 0.05 to 1.2 g/cm³. For use as a mattress or as an automotive seat, it is preferable to set a density in the range from 0.05 to 0.25 g/cm³, while for use as a shoe sole it is preferable to set a density in the range from 0.1 to 0.8 g/cm³ and preferably in the range from 0.1 to 0.6 g/cm³.

When polyurethane foams according to the present invention are used as a shoe sole, the shoe soles will be surrounded on the outside by a water-impervious material, for example rubber. This is intended to prevent wetness getting into the foam of the present invention from the outside, for example in the event of rain.

A process according to the present invention is simple to carry out, and metering 3 components in one mixing head to form reaction mixtures to produce polyurethane foams is unproblematical. Injection into molds gives molded foams having complicated geometries in a way which is simple, quick and essentially generates no scrap. It is further possible to produce composited materials, for example shoes, by directly foaming the foam of the present invention onto a substrate material, for example the sole material on the upper, in one operation without use of adhesives.

The process of the present invention provides polyurethane foams having a high level of water-absorbing polymer. The presence of latent heat storage media (g) leads by virtue of their temperature-regulating properties to a further increase in the sense of well being. The polyurethane foams of the present invention have advantageous mechanical properties, for example low swellability. These advantageous properties will now be illustrated in the form of examples.

### Materials Used:

Polyol 1: polyetherol based on glycerol, propylene oxide and ethylene oxide and having an OH number of 31 mg of KOH/g and a viscosity of 800 mPas at 25° C.
Polyol 2: Lupranol® 4800 from Elastogran GmbH; polymer polyetherol having a solids content of 45% by weight and an OH number of 20 mg of KOH/g.
Crosslinker: glycerol
Chain extender: monoethylene glycol
Cat 1: catalyst based on a tertiary amine dissolved in 1,4-butanediol
Cat 2: catalyst based on a tertiary amine dissolved in dipropylene glycol
Cat 3: catalyst based on a tertiary amine
Stabilizer: cell stabilizer based on a silicone
Iso 135/74: isocyanate prepolymer from Elastogran GmbH, based on 4,4′-MDI-modified isocyanates and a mixture of polyetherols having an average functionality of 1.5 to 2.0 and an NCO content of 23.8% by weight
SAP 1: Luquasorb® 1010 superabsorbent from BASF AG
SAP 2: Luquasorb® 1060 superabsorbent from BASF AG
PCM: Ceracap® NB 1007 X latent heat storage phase change material from BASF AG

TABLE 1

| | Comparative | | | |
|---|---|---|---|---|
| | Example V1 | Example 1 | Example 2 | Example 3 |
| Component A1 | | | | |
| Polyol 1 | 83.81 | 58.37 | 58.37 | 53.66 |
| Polyol 2 | 11.77 | 11.72 | 11.72 | 11.18 |
| Glycerol | 1.26 | 1.25 | 1.25 | 1.19 |
| Water | 1.21 | 1.20 | 1.20 | 1.15 |
| Cat 1 | 1.15 | 1.15 | 1.15 | 1.11 |
| Cat 2 | 0.04 | 0.04 | 0.04 | 0.04 |
| Cat 3 | 0.26 | 0.26 | 0.26 | 0.25 |
| Stabilizer | 0.50 | 0.50 | 0.50 | 0.48 |
| Component A2 | | | | |
| SAP 1 | | 5.51 | | |
| SAP 2 | | | 5.51 | 10.94 |
| Polyol 1 | | 20.00 | 20.00 | 20.00 |
| Component B | | | | |
| Iso 135/74 | 38.40 | 37.80 | 37.70 | 36.20 |

Examples 1 to 3 and Comparative Example V1 were carried out by combining components A1, if appropriate A2 and B immediately before foaming and mixing them together briefly but intensively. The reaction mixture was subsequently poured into a plate mold having the dimensions 20×20×0.5 cm and the mold closed. After the reaction, several test specimens were cut out of the polyurethane plates of Examples 1 to 3 and Comparative Example V1. The test specimens were conditioned at room temperature and 50% relative humidity for 24 hours and subsequently tested for water vapor absorption in a conditioning cabinet at 40° C. and 90% relative humidity. Table 2 provides information on the water vapor absorption of the polyurethane foams:

TABLE 2
Water vapor absorption of various polyurethane foams

Increase in mass [% by weight]

| Period | Comparative | | | |
|---|---|---|---|---|
| [min] | Example 1 | Example 1 | Example 2 | Example 3 |
| 0 | 0.0 | 0.0 | 0.0 | 0.0 |
| 60 | 1.6 | 5.1 | 4.1 | 5.1 |
| 90 | 1.6 | 5.8 | 4.2 | 6.5 |
| 120 | 1.6 | 6.4 | 4.6 | 6.8 |
| 150 | 1.5 | 6.5 | 4.6 | 7.3 |
| 180 | 1.5 | 6.4 | 4.5 | 7.2 |

Examples 1 to 3 show that the polyurethane foams produced have a significantly greater water vapor absorption than Comparative Example 1.

Machine trials were carried out on a low pressure system from Elastogran Maschinenbau (model F20). The machine has three stock reservoir vessels, two vessels containing components A1 and A2 and the third vessel containing component B. The three different components were intimately mixed with one another in the mixing head and discharged into a sole mold for a footbed. Table 3 shows the composition of the components used.

TABLE 3
Composition of components used

| | Comparative | | |
|---|---|---|---|
| | Example 2 | Example 4 | Example 5 |
| Component A1 | | | |
| Polyol 1 | 83.30 | 56.60 | 24.50 |
| Polyol 2 | 11.75 | 11.75 | 11.75 |
| Chain extender | 0.45 | 0.45 | 0.45 |
| Glycerol | 1.25 | 1.25 | 1.75 |
| Water | 1.25 | 1.25 | 1.25 |
| Cat 1 | 1.20 | 1.20 | 1.44 |
| Cat 2 | 0.04 | 0.04 | 0.05 |
| Cat 3 | 0.26 | 0.26 | 0.31 |
| Stabilizer | 0.50 | 0.50 | 0.50 |
| PCM | | | 5.00 |
| Component A2 | | | |
| Polyol 1 | | 18.69 | 45.05 |
| SAP 1 | | 8.01 | 7.95 |
| Component B | | | |
| Iso 135/74 | 38.30 | 41.10 | 43.90 |

The molded articles produced were conditioned at room temperature and 50% relative humidity for 24 hours, similarly to examples 1 to 3. Their water vapor absorption was subsequently determined at 40° C. and 90% relative humidity. The values obtained are reported in table 4.

TABLE 4
Water vapor absorption of footbeds produced

| | Increase in mass [% by weight] | | |
|---|---|---|---|
| Period | Comparative | | |
| [min] | Example V2 | Example 4 | Example 5 |
| 120 | 1.7 | 7.1 | 6.2 |

In addition, the desorption behavior of the polyurethane foam was investigated on Example 4. To this end, the specimen was stored at 40° C. and 90% relative humidity for 120 minutes before being kept at room temperature and 50% relative humidity while its mass was determined at defined intervals. Table 5 provides information on the desorption behavior of the specimen.

TABLE 5
Desorption behavior of example 4 after water
vapor absorption (120 min/40° C., 90%
relative humidity; starting weight 76.8 g)

| Period | Sample weight |
|---|---|
| [h] | [g] |
| 0 | 82.3 |
| 2 | 80.2 |
| 3 | 79.5 |
| 4 | 79.0 |
| 5 | 78.6 |
| 6 | 78.3 |
| 7 | 77.9 |
| 8 | 77.6 |
| 16 | 77.5 |
| 24 | 76.8 |

Table 5 shows that water vapor absorption is reversible. 75% of the sorbed water is desorbed within 8 hours at room temperature and 50% relative humidity, and after 24 hours the sorbed water has been completed desorbed.

1-18. (canceled)

19: A shoe sole comprising a polyurethane foam prepared in a batch process by mixing
a) polyisocyanates with
b) at least one higher molecular weight compound having at least two reactive hydrogen atoms and
c) optionally low molecular weight chain-extending and/or crosslinking agents
d) blowing agents optionally comprising water,
e) catalysts,
f) water-absorbing polymers,
g) optionally capsules containing latent heat storage media and
h) optionally miscellaneous additive materials,
and reacting the resulting reaction mixture to form the polyurethane foam,
wherein either the blowing agent d) comprises no water or if the blowing agent d) comprises water, blowing agent d) and water-absorbing polymer f) are only brought into contact in the course of the reaction mixture being formed.

20: The shoe sole according to claim 19 wherein the blowing agent d) comprises water.

21: The shoe sole according to claim 20 wherein the water content of the components (b) to (h) is in the range from 0.1 to 2% by weight, based on the total weight of the components (a) to (h).

22: The shoe sole according to claim 19 wherein the content of the capsules containing latent heat storage media is in the range from 1 to 20% by weight, based on the total weight of the components (a) to (h).

23: The shoe sole according to claim 19 wherein the content of the water-absorbing polymer is in the range from 1 to 20% by weight, based on the total weight of the components (a) to (h).

24: The shoe sole according to claim 19 wherein the surface of the water-absorbing polymer is in a postcrosslinked state.

25: The shoe sole according to claim 19 wherein the water-absorbing polymer has a particle diameter in the range from 0.01 mm to 1 mm.

26: The shoe sole according to claim 19 wherein the components b) to h) are present in at least two polyol components A1 and A2 and the reaction mixture is obtained by mixing the polyol components and at least one isocyanate component (B) comprising polyisocyanates (a), wherein the component (A1) comprises no water-absorbing polymer and the component (A2) comprises essentially no water.

27: The shoe sole according to claim 26 wherein the catalyst e) is present in component (A1).

28: The shoe sole according to claim 26 wherein the viscosities of the components (A1) and (A2) differ by less than 50%, based on the viscosity of the more viscous component.

29: The shoe sole according to claim 19 wherein the water-absorbing polymers are added as a solid material in a mixing head to the components (a) to (e) and also (g) and (h).

30: The shoe sole according to claim 19 wherein the reaction mixture is introduced into a mold.

31: The shoe sole according to claim 19 wherein the polyurethane foam has a 90% DIN ISO 4590 volume percentage of open cells.

32: The shoe sole according to claim 19 that is surrounded on the outside by a water-impervious material.

33: The shoe sole according to claim 19 that is an insole.

34: The shoe sole according to claim 19 that is a footbed.
